(19) United States
(12) Patent Application Publication
(10) Pub. No.: US 2026/0236049 A1
(43) Pub. Date: Aug. 13, 2026

(54) CIRCUITS AND METHODS FOR RELIABLE STARTUP OF BANDGAP REFERENCE CIRCUITS

(71) Applicant: EM MICROELECTRONIC-MARIN SA, Marin-Epagnier (CH)

(72) Inventor: Jiri NERAD, Praha (CZ)

(73) Assignee: EM MICROELECTRONIC-MARIN SA, Marin-Epagnier (CH)

(21) Appl. No.: 19/422,989

(22) Filed: Dec. 17, 2025

(30) Foreign Application Priority Data
Feb. 12, 2025 (EP) 25157474.5

(51) Int. Cl. G05F 1/46

(52) U.S. Cl. CPC G05F 1/468; G05F 1/461

(57) ABSTRACT

A method for obtaining reliable startup of a bandgap reference circuit, the bandgap reference circuit including a bandgap core with at least two branches, a feedback loop, and a startup circuit. The method includes generating a startup stimulus with an initial magnitude sufficient to transition the circuit from an inactive state to an active state, controlling the decline of the startup stimulus by regulating its reduction progressively over time, and modifying local time constants of the bandgap reference circuit to prevent a condition in which the transient decline of a voltage across a first branch is faster than the transient decline of a voltage across a second branch. By doing so, the voltages across the branches of the bandgap core converge to a target operating point, ensuring a reliable startup of the bandgap reference circuit.

### CROSS REFERENCE TO RELATED APPLICATIONS

This application claims priority to European Patent Application No. 25157474.5 filed February 12, 2025, the entire contents of which are incorporated herein by reference.

### Field of the Invention

The invention relates to analog and mixed-signal integrated circuit design. It specifically addresses the reliable startup of bandgap reference circuits under various operating conditions.

### Background of the Invention

Bandgap reference circuits are essential components of modern analog integrated circuit design, providing a stable reference voltage with minimum dependence on supply voltage, temperature, and process variations. Traditional designs incorporate startup circuits to transition the bandgap reference from an inactive to an active state. Both static and dynamic startup methods have been developed, often using pulse generators to initiate the feedback loop.

However, existing startup circuits can exhibit operational challenges due to mismatches between the startup pulse characteristics and the dynamic response of the feedback loop controlling the bandgap reference circuit. This issue is particularly relevant to low-power applications or circuits requiring high reliability during rapid startup sequences. Previous solutions have primarily focused on tuning the magnitude of startup pulses, often overlooking the interactions between the feedback time constants and the transient pulse shape.

These challenges can lead to issues such as uncertainty in converging to the target operating point or slower-than-expected startup responses, potentially leading to situations where the entire integrated circuit fails to meet its timing specifications or even fails to start up.

The present invention addresses these challenges by providing a solution that improves the reliability of startup techniques used in bandgap reference systems. The invention aims to resolve the transient interaction effects during the startup process, thereby facilitating fast and robust system initialization across a broad range of operating conditions without compromising the static performance in the active mode.

### Summary of the Invention

According to one aspect of the invention, a method for obtaining reliable startup of a bandgap reference circuit is disclosed, wherein the bandgap reference circuit comprises a bandgap core with at least two branches, a feedback loop, and a startup circuit. The method generates a startup stimulus with an initial magnitude sufficient to transition the circuit from an inactive state to an active state. The method includes controlling the progressive reduction of this stimulus over time. Furthermore, the method includes modifying local time constants of the bandgap reference circuit to prevent a condition in which the transient decline of a voltage across one branch is faster than the transient decline of a voltage across another branch. This ensures convergence of the branch voltages to the target operating point, achieving stable startup. The technical advantage lies in improved reliability of the bandgap reference circuit, avoiding startup failures that can occur in prior art methods.

The progressive reduction of the startup stimulus can be achieved through an analog steering mechanism, which generates a continuous or gradual reduction in magnitude.

The decline of the startup stimulus might be controlled by a digital steering mechanism that produces a sequence of pulses with stepwise decreasing magnitudes, providing the technical advantage of implementing a predictable and controlled startup process. The sequence of pulses ensures that the startup stimulus is reduced in a controlled manner.

In the context of the invention, a design tool refers to a simulation or modeling method implemented on a computer to aid in the design of a bandgap reference circuit. The tool allows for analyzing and optimizing the startup behavior by simulating the progressive reduction of a startup stimulus and modifying local time constants to prevent failure conditions where the transient decline of voltages across the bandgap core branches fails to converge to the desired static operating point. The tool addresses real-world technical problems such as instability, startup failures, and excessive power consumption, which are critical concerns in analog and mixed-signal circuit design. By providing insights into the dynamic behavior of the circuit under various operating conditions, the tool enables designers to achieve reliable startup and convergence to a target operating point. This simulation produces a technical effect by improving the performance and reliability of the final physical circuit, thereby solving a clearly defined technical problem.

Modifying local time constants of the bandgap reference circuit might include attaching a timing capacitor between a first branch of the bandgap core and a reference potential and determining the minimum capacitance of said capacitor to prevent the failure condition and provides the technical advantage of controlling the transient behavior of the branches. By attaching the timing capacitor and ensuring its capacitance is sufficient, the method provides the correct order of transient decline of voltages across the branches, avoiding the failure mode.

Modifying local time constants of the bandgap reference circuit can include attaching a capacitor at the output of an operational amplifier in the feedback loop and determining the minimum capacitance of said capacitor to prevent the condition. It provides the technical advantage of slowing down the feedback control process and avoiding fast decline of voltages across the bandgap core branches. This ensures that the transient decline of said voltages is aligned with the static characteristics used to design the bandgap reference circuit.

Modifying local time constants of the bandgap reference circuit may comprise sizing the capacitance of the Miller compensation capacitor, after determining the minimum capacitance of the Miller compensation capacitor to prevent the condition. It provides the technical advantage of slowing down the feedback control process and avoiding fast decline of voltages across the bandgap core branches. This ensures that the transient decline of said voltages is aligned with the static characteristics used to design the bandgap reference circuit.

Modifying local time constants of the bandgap reference circuit may comprise sizing the bandwidth of the feedback loop, after determining the maximum bandwidth to prevent the condition. It provides the technical advantage of slowing down the feedback control process and avoiding fast decline of voltages across the bandgap core branches. This ensures that the transient decline of said voltages is aligned with the static characteristics used to design the bandgap reference circuit.

Modifying local time constants of the bandgap reference circuit may comprise sizing the unity gain frequency of the feedback loop, after determining the maximum unity gain frequency to prevent the condition.

Modifying local time constants of the bandgap reference circuit may comprise configuring the startup circuit to limit the maximum amplitude of the startup pulse, providing the technical advantage of preventing the strong overdrive that is a necessary condition of the failure mode.

According to a second aspect of the invention, a bandgap reference circuit obtained by the first aspect of the invention is disclosed. It provides the possibility of achieving a reliable startup process with a design methodology that ensures reliable convergence of voltages across the branches of the bandgap core. By leveraging the controlled generation and progressive reduction of a startup stimulus, combined with the modification of local time constants to provide the correct order of transient decline of voltages across the branches, the circuit inherently avoids conditions that could lead to the failure mode.

According to a third aspect of the invention, a circuit comprising a bandgap reference circuit obtained as in the second aspect of the invention and a startup circuit is disclosed. It provides the possibility of achieving a highly configurable and adjustable startup process. The startup circuit includes a voltage comparator configured to compare two input voltages, where either input can be connected to a net of the bandgap core or ground, with the flexibility to further combine the various configuration options with various values of the input offset voltage of the comparator circuits. This comparator output is processed by an analog or digital control block, allowing implementation with both analog and digital design methodologies. Furthermore, a converter generates a startup pulse based on the output signal of the control block, ensuring that the stimulus can be applied to the bandgap reference circuit as appropriate.

The voltage comparator may comprise a hysteresis mechanism configured to introduce a predefined offset between a rising input threshold and a falling input threshold, providing the possibility of enhancing stability and preventing oscillations during transitions between high and low states. The hysteresis mechanism ensures that small variations in the input signals do not lead to unintended toggling of the comparator output, thereby improving the robustness of the startup process. The technical advantage is the reduction of oscillatory behavior that can compromise the reliability of the circuit.

The startup circuit may comprise an additional offset voltage independently applied to one or both inputs of the comparator, providing the possibility of tuning the transition point of the comparator. This capability allows the circuit designer to adjust the sensitivity and thresholds of the comparator to align with specific design requirements. The technical advantage is a highly configurable comparator that can be adapted to match the properties of the bandgap reference circuit.

### Brief Description of the Drawings

The present invention will be described subsequently in more detail with reference to the attached drawings, given by way of examples, but in no way limited thereto, in which:

FIG. 1: A schematic diagram illustrating the series configuration of a bandgap reference circuit,

FIG. 2: A schematic diagram illustrating the parallel configuration of a bandgap reference circuit,

FIG. 3: Displays simulation results showing the transient effects of moderate and excessive pulse currents applied to the bandgap core alone,

FIG. 4: A plot showing the static relationship between the voltages across the bandgap core branches and the bias current,

FIG. 5: Correct system response to a moderate pulse,

FIG. 6: Failure mode following a large start pulse with fast ramp down,

FIG. 7: Successful start of the bandgap reference circuit following a large start pulse with gradual or slow ramp down,

FIG. 8: Start circuit with analog steering,

FIG. 9: Start circuit with digital steering,

FIG. 10: Timing diagram for analog steering,

FIG. 11: Timing diagram for digital steering (stepwise decline),

FIG. 12: Timing diagram for digital steering (train of pulses).

### DETAILED DESCRIPTION OF THE INVENTION

The bandgap reference is one of the fundamental building blocks used in analog integrated circuits, serving as a reference circuit to generate either a constant voltage or a current proportional to absolute temperature.

This circuit typically includes a network of diode-connected bipolar transistors and resistors forming two branches, collectively referred to as the bandgap core. It also comprises two MOS devices configured as controlled current sources to supply bias currents to the bandgap core, and an operational amplifier that senses the voltages within the bandgap core. The operational amplifier generates a common control signal for the controlled current sources, forming a negative feedback loop known as the bandgap feedback loop. The fundamental design principles of these components, which ensure the generation of the desired reference voltage or current, are well established and do not form the subject of this invention.

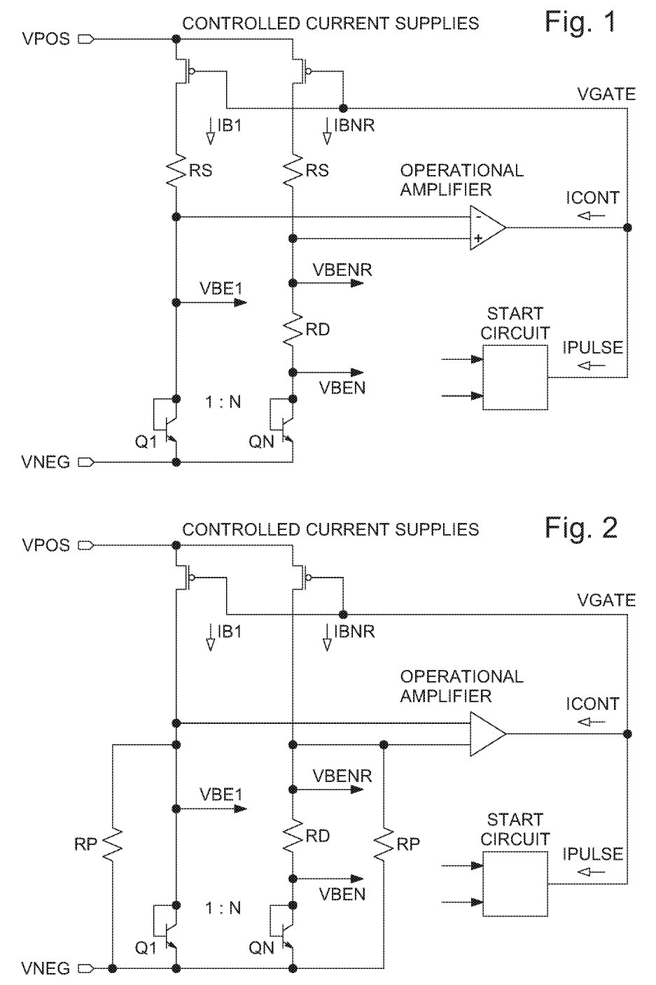

Two primary configurations of bandgap circuits exist: the series bandgap topology illustrated in FIG. 1 and the parallel bandgap topology illustrated in FIG. 2.

Both configurations comprise a bandgap core with bipolar transistors and resistors, two MOS transistors functioning as controlled current sources, and an operational amplifier, as described above.

In typical implementations, transistors Q1 and QN are of the same type, with QN having an emitter area N-times larger than Q1. QN is often implemented as N parallel units, each identical to Q1. Furthermore, in the target operating point, the bias currents IB1 and IBNR are identical and greater than zero, and, due to a very large gain of the operational amplifier, the voltages VBE1 and VBENR are also identical. Consequently, the voltage VBE1 is greater than the voltage VBEN, their difference being copied onto the difference resistor RD. Finally, it should be noted that, in a practical series bandgap design, the series resistor RS in FIG. 1 is significantly greater than the difference resistor RD, or, in a practical parallel bandgap design, the parallel resistor RP in FIG. 2 is significantly greater than the difference resistor RD.

Although extensive technical literature exists on the design and operation of bandgap reference circuits, much of it does not address the challenges associated with power-up, start-up, or wake-up events.

By principle, every bandgap feedback loop possesses two stable operating points: a desired or target operating point defined by the bandgap design equations, and an undesired point typically associated with zero bias currents and voltages.

To overcome this, startup circuits are integrated into bandgap systems. These circuits apply a stimulus or pulse to drive the feedback loop from the undesired zero-bias state to the target operating point. A static startup circuit triggers the pulse based on specific conditions within the circuit, while a dynamic startup circuit uses time dependent or event driven signals, such as power-on or enable signals.

Various examples, such as those depicted in FIGS. 1 and 2 demonstrate how static startup blocks can be integrated into the full bandgap system where it senses one or more voltages at one or more nets or between any two nets in the bandgap core as indicated by the arrows, and applies a pulse current IPULSE to the control branch, effectively in parallel with the output current ICONT of the operational amplifier. Other bandgap systems exist where the startup part is connected differently. In particular, the stimulus or pulse current can be applied directly to one or more nets of the bandgap core. Alternatively, a single and time limited pulse can be applied on powering up the bandgap block or on activating its enable signal which is called a dynamic startup as the condition of applying the stimulus or pulse typically depends on an external event or signal.

The techniques and mechanisms described in this invention disclosure are applicable to various types of startup methods, including static and dynamic approaches.

The combination of time constants of the bandgap feedback loop on one hand and the transient timing of the startup pulse on the other, can bring a design issue that may result in startup timing failure. The problem is not due to insufficient strength or magnitude of the startup pulse. Rather, the start failure is typically due to application of analog pulse of excessive strength with very fast transient decline of such pulse, as explained below.

### Simulation of bandgap core

FIG. 3 shows a simulation of voltages at the two branches VBE1, VBENR of the bandgap core where the two respective bias currents IB1, IBNR are applied and steady at time of 0 nanoseconds, kept constant between 0 nanoseconds and 200 nanoseconds, and stopped at time of 200 nanoseconds, both currents decreasing from the full initial value down to zero value in units of nanoseconds. In response to the driving bias currents, the voltages VBE1, VBENR are also constant between 0 nanoseconds and 200 nanoseconds, and then, after the bias currents are stopped these bias voltages converge to zero voltage, at a speed that corresponds to the time constants in this part of the circuit.

The top section of the diagram shows a transient simulation for a moderate pulse, that is, a moderate initial magnitude of bias currents IB1, IBNR, where even the initial voltage VBENR across the series diode resistor branch is below 800 millivolts. In contrast, the bottom section of the diagram shows a transient simulation for an excessive stimulus, that is, an excessive initial magnitude of bias currents IB1, IBNR, where the initial voltage VBENR across the series diode resistor branch exceeds 1.6 volts.

For the purpose of this invention it is important to note that, after the end of the moderate pulse (FIG. 3, top), while decreasing to zero, both voltages VBE1, VBENR also converge to each other and the respective traces have crossing points, whereas, after the end of the excessive pulse (FIG. 3, bottom), there is no such convergence and voltage VBENR remains higher than voltage VBE1, with no crossing points.

The transient effect where VBENR remains higher than VBE1 need not necessarily occur in all bandgap implementations. However, the risk is significant, not only due to poor control over parasitic capacitances but also due to the combination of initial currents and current densities in the bipolar devices. Specifically, in the parallel bandgap configuration shown in FIG. 2 operating with low supply voltage, the linear resistor RD can operate as current limiting element, preventing large or excessive increase of the bias current IBNR via the transistor device QN. In contrast, in the branch supplying the bias current IB1 into the transistor device Q1, there is no such element, and for the control voltage VGATE approaching zero or ground, the current IB1 keeps increasing without saturation. Consequently, at the end of the large or excessive start pulse, the current via Q1 can be significantly larger than the current via the series combination of QN and RD, resulting in a situation where VBE1 decreases faster and from smaller initial value than VBENR, again bringing a situation where VBENR remains higher than VBE1.

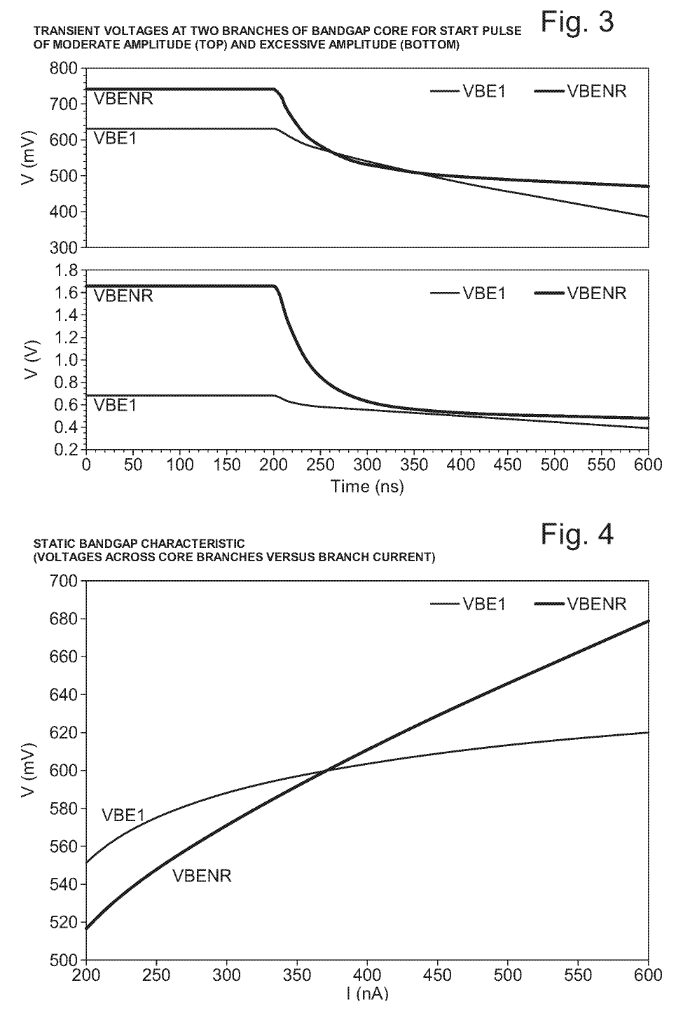

The transient behavior described in the previous paragraph may contribute to the failure to start the bandgap system under certain conditions. This is because all bandgap loops, series or parallel, are designed to reach the target static operating point as illustrated in FIG. 4 showing the static voltages at the two branches VBE1, VBENR on the vertical scale versus the bias currents IB1, IBNR which are identical, with a single value shown on the horizontal scale.

In more detail, all bandgap loops, series or parallel, are designed to operate in such a way that if VBE1 is greater than VBENR, the loop regulates up, that is, the operational amplifier steers the controlled current supplies to increase the bias currents IB1, IBNR, and conversely, if VBE1 is smaller than VBENR, the loop regulates down, that is, the operational amplifier steers the controlled current supplies to decrease the bias currents IB1, IBNR. In this way, the system uses negative feedback to converge to the desired operating point corresponding to the crossing point of the two static traces in FIG. 4.

However, the above transient simulations indicate that, if the bandgap core enters the failure mode illustrated in FIG. 3 where both voltages VBENR, VBE1 keep declining but voltage VBENR is permanently higher than voltage VBE1, then the loop can never regulate up in order to stop the decline of said voltages. Consequently, in that case, the feedback loop keeps moving away from the target operating point down to the zero-operating point from which it cannot recover.

The principal cause of the failure is the misalignment between the static design characteristics as presented in FIG. 4 and the transient decline of the operating point as presented in FIG. 3, wherein the transient difference between the voltages VBENR, VBE1 reached at low values of the transient bias current is opposite to the respective static difference obtained for low values of the static bias current.

### Simulation of full bandgap loop

In the previous section, a simulation of the bandgap core alone is used to identify a risk of failure mode. In this section, example simulations of the full bandgap system as drawn in FIGS. 1 and 2 are presented to confirm the existence of such failure mode and indicate the techniques to prevent it.

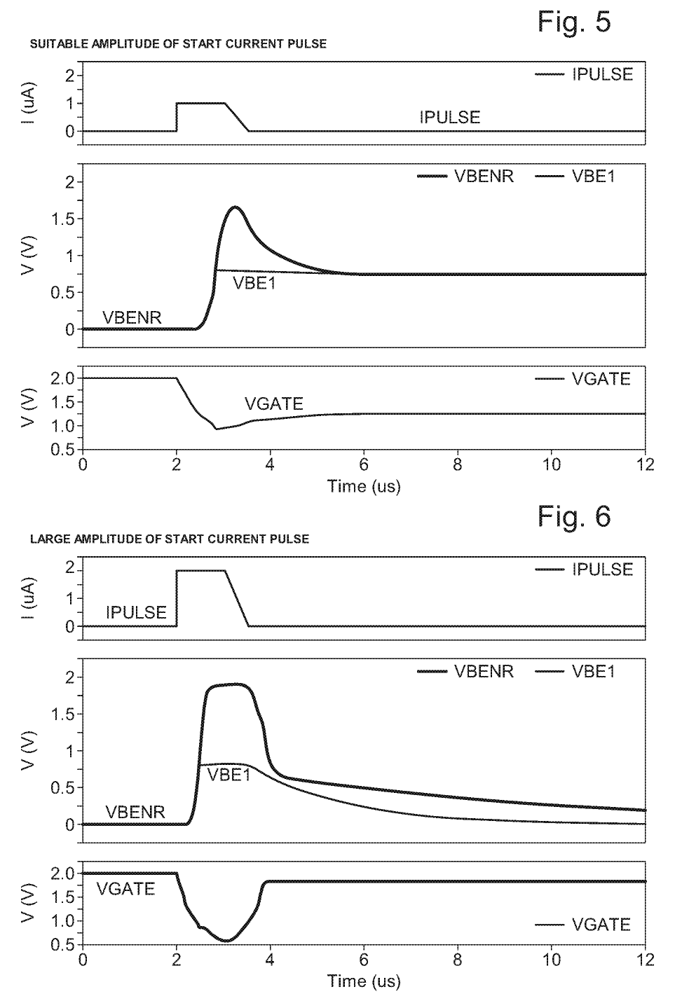

Specifically, transient simulations of the parallel bandgap system architecture as shown in FIG. 2, with voltage and current quantities as marked in FIG. 2, are presented in FIGS. 5, 6 and 7. In each diagram, the top section shows the pulse current IPULSE, the middle section shows the bandgap core voltages VBE1, VBENR, and the bottom section shows the control voltage for the bias current supplies, that is the gate terminal voltage VGATE of the two respective PMOS transistors which is also the output voltage of the operational amplifier in FIG. 2. However, regarding the bandgap core voltages VBE1, VBENR, the driving bias currents IB1, IBNR, and the related control voltage VGATE, the series bandgap system architecture shown in FIG. 1 has transient behavior that is very similar or almost identical to that presented in FIGS. 5, 6 and 7 for the parallel configuration.

Both architectures are compatible with the method described in this invention disclosure, as the method is designed to handle the relation between the large signal response and the related time constants of the feedback loop on one hand and the magnitude and ramp down time or shutdown time of the start pulse or stimulus on the other. Such timing considerations apply to both architectures in the same way.

FIG. 5 shows the behavior of the bandgap system for a suitable or moderate magnitude of the stimulus current IPULSE. As can be seen, when the stimulus is applied, the bandgap core voltages VBE1, VBENR reach values higher than the respective levels corresponding to the target operating point. Also, the control voltage VGATE reaches a value lower than the value corresponding to the target operating point which indicates that the bias currents IB1, IBNR are higher than their values in the target operating point since the controlled current supplies are PMOS transistors, giving larger drain currents for lower voltages at gate terminals. However, after the stimulus current is stopped, all voltages and currents converge to the target operating point where the voltages VBE1, VBENR are equal and nonzero, and the voltage VGATE is steady and lower than the supply voltage, indicating steady and nonzero bias currents IB1, IBNR, which are identical by design.

The pulse current IPULSE has a moderate amplitude of 1 microampere and a relatively fast falling edge of 500 nanoseconds but, as the simulation confirms, fast ramp down or shutdown combined with moderate magnitude means no issue for the operation of the full system.

In contrast, FIG. 6 shows the behavior of the circuit for a large or excessive magnitude of the pulse current using the same timing. In particular, the magnitude is increased to 2 microamperes while the falling edge time is maintained at 500 nanoseconds. As can be seen, after the stimulus current is stopped, the system enters the failure mode indicated by earlier analysis of the bandgap core alone. The bandgap core voltages VBE1, VBENR keep declining but do not converge to each other and VBENR is permanently higher than VBE1. Also, the control voltage VGATE converges to the supply voltage meaning little or no bias current via the controlled current supplies. In conclusion, the system departs further away from the target operating point and converges to the zero-operating point.

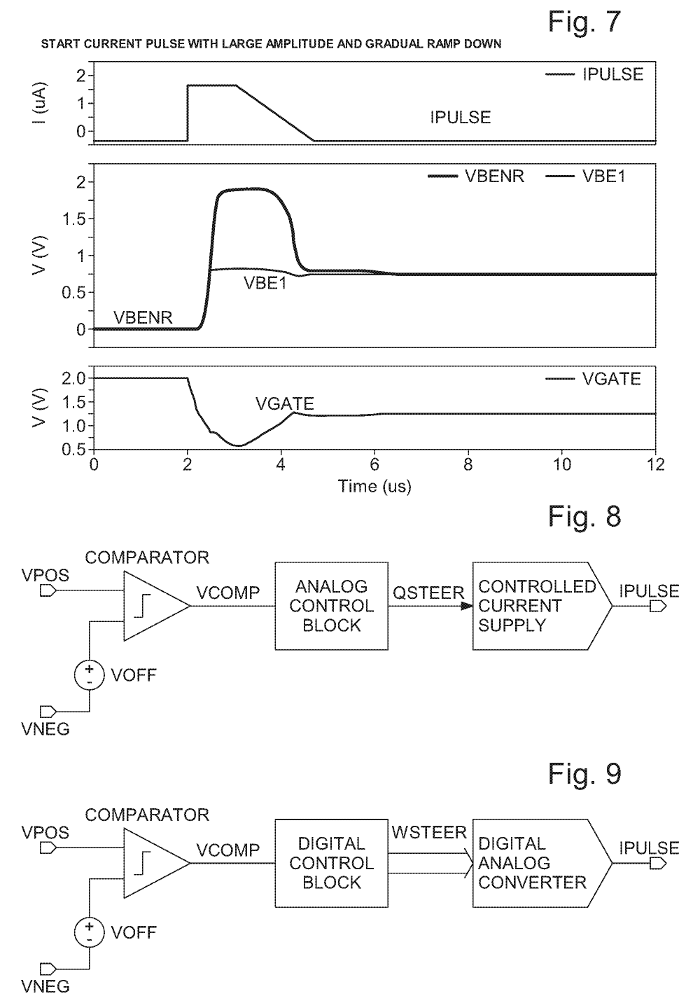

Finally, the solution to the functional issue and the principle to prevent the failure mode is illustrated in FIG. 7 which shows the behavior of the circuit for the same magnitude of the stimulus current as that used in FIG. 6, that is the magnitude is again 2 microamperes, meaning large or excessive drive. However, the falling edge time is extended to 2 microseconds, that is four times longer than that used in FIG. 6. As can be seen from FIG. 7, the large initial stimulus means high initial bandgap core voltages VBE1, VBENR as well as low initial gate control voltage VGATE indicating large initial bias currents IB1, IBNR. However, despite such initial point, as the pulse or stimulus is gradually ramped down, the system quickly converges to the target operating point where the bandgap core voltages VBE1, VBENR are equal and nonzero, the gate control voltage VGATE is below the supply voltage, and consequently, the bias currents IB1, IBNR, designed to be equal, are also greater than zero.

To address the failure mode and ensure a reliable startup, the stimulus current must gradually transition from a large or excessive magnitude, through a suitable or moderate range, to zero, with a controlled rate of change. This approach allows sufficient transition time for the system components, including the bandgap core, operational amplifier, and feedback loop, to stabilize effectively.

As shown in FIG. 7, this method requires only a minimal additional time. During the ramp down phase, the system reaches a state very close to the target operating point, enabling immediate usage once the pulse ends. This ensures a balance between operational reliability and startup speed, making the method both efficient and robust under varying conditions.

### Design considerations

As described above, the failure is typically linked to large or excessive magnitude of the start stimulus or pulse. Generally, such situation is very difficult to avoid because such magnitude has to be designed to be sufficient over all combinations of supply voltage, temperature and process corner representing technology variation. In other words, the minimum magnitude over all operating conditions has to be large enough for the start event to be reliable. However, in the same silicon design, the ratio between the maximum and minimum pulse magnitude over all conditions is typically larger than one decade. In summary, while the minimum output pulse magnitude has to be large enough to obtain reliable start, the maximum possible pulse magnitude will be ten times larger or even greater than that. Consequently, the circuit has to manage a situation where the start pulse is excessive or much larger than needed.

The method proposed in this invention disclosure provides an alternative approach that is not achieved by modifications to the bandgap feedback loop alone. In particular, designing for narrow bandwidth of the main bandgap loop in order to obtain slow decline of the control voltage VGATE and hence the controlled bias currents IB1, IBNR is not generally applicable as it means a design conflict with the requirements on the regular bandgap performance. This is because the bandwidth of the bandgap feedback loop is directly related to the key bandgap performance parameters such as power supply rejection or output noise spectrum. By principle, the start circuit is unrelated to the bandgap performance as it is inactive during regular operation where it shall cause no interference.

### Proposed circuit and methods

This section introduces the general topology and operation of the start circuit designed to eliminate the failure mode analyzed earlier. To accommodate different design requirements, the invention provides two variants of the start circuit, distinguished by the method of control at the output stage. These are: (i) a start circuit with analog steering, depicted in FIG. 8, and (ii) a start circuit with digital steering, shown in FIG. 9.

In the analog steering configuration, the output stage is modulated using continuous control signals, allowing precise real-time adjustments. In contrast, the digital steering configuration employs discrete control states or steps, simplifying implementation and potentially improving robustness in certain scenarios. Both configurations address the transient timing challenges identified earlier and are designed to achieve reliable and consistent startup performance.

FIGS. 8 and 9 provide detailed schematics of these configurations, illustrating the key components and control pathways. These variations demonstrate the range of different operational requirements and technological constraints covered by this invention.

FIG. 8 illustrates the start circuit with analog steering. The circuit includes a comparator that compares two input voltages VPOS and VNEG. The output of the comparator, VCOMP, is processed by an analog control block to generate a continuous control signal QSTEER. This signal modulates a current-controlled or voltage-controlled source that produces the startup pulse IPULSE. The gradual decline of QSTEER ensures the controlled ramp- down of IPULSE, allowing the system to stabilize without entering the failure mode.

FIG. 9 shows the start circuit with digital steering. The comparator generates an output signal VCOMP, which is processed by a digital control block to produce a digital control word WSTEER. This word controls a digital-to-analog converter (DAC) that generates the startup pulse IPULSE. The gradual decline of WSTEER occurs stepwise, ensuring a controlled and predictable ramp-down of IPULSE. This approach simplifies implementation while maintaining robust startup performance.

Both topologies or flavors have the same front stage which comprises a voltage comparator with or without hysteresis and with optional offset represented by a voltage supply VOFF. This aligns with prior art where many start circuit architectures are based on comparison of a voltage at a net in the bandgap core against a fixed value or comparison of a differential voltage between two nets in the bandgap core against a fixed value. In the same way, the front stage in FIGS. 8 and 9 performs comparison of two input voltages, VPOS and VNEG, where either of these inputs can be connected to a net of the bandgap core or ground as indicated by arrows in FIGS. 1 and 2, and VOFF can be any value to represent many combinations or variants that are presently in use.

It is important to stress that FIGS. 8 and 9 illustrate practical configurations of interfaces of the start circuit where the input interface operates in voltage mode, that is, senses one or more voltages at outside nets, and the output interface operates in current mode, that is, applies or injects current to an outside branch.

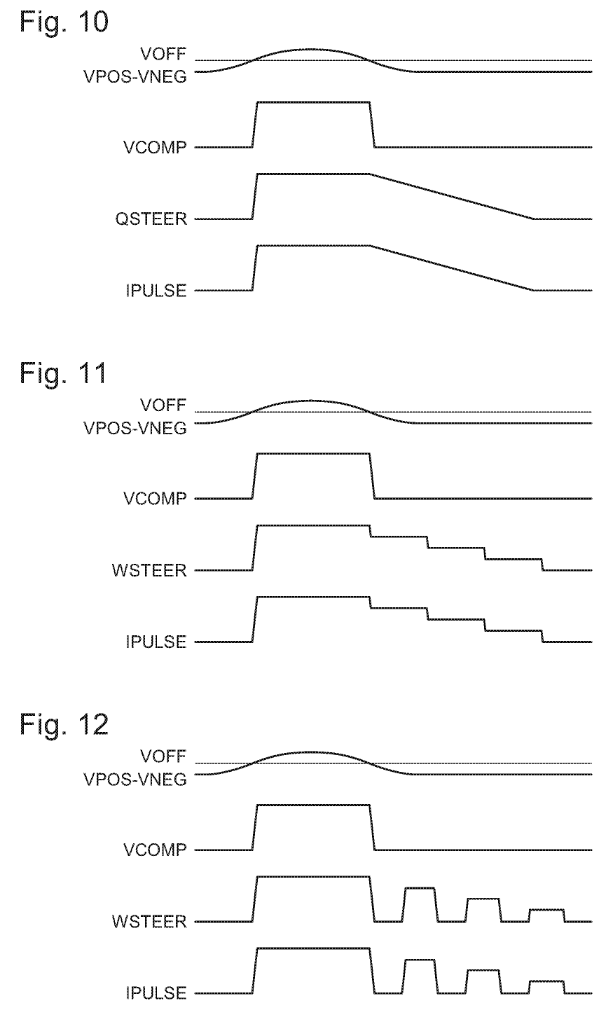

FIG. 10 illustrates the timing behavior for the analog steering mechanism. The differential input voltage VPOS−VNEG is compared against an offset voltage VOFF. The comparator output voltage VCOMP is low when the differential input voltage VPOS-VNEG is smaller than the offset voltage VOFF, and conversely, VCOMP is high when VPOS-VNEG is larger than VOFF. When VPOS-VNEG becomes larger than VOFF and VCOMP makes a rising transition, the control signal QSTEER ramps up quickly. In contrast, when VPOS-VNEG becomes smaller than VOFF and VCOMP makes a falling transition, QSTEER declines gradually over time, ensuring the startup pulse IPULSE decreases slowly, allowing the feedback loop to adjust correctly as illustrated in FIG. 7.

FIG. 11 depicts the timing behavior for the digital steering mechanism. Again, VCOMP is low when VPOS-VNEG is smaller than VOFF, and conversely, VCOMP is high when VPOS-VNEG is larger than VOFF. When VPOS-VNEG becomes larger than VOFF and VCOMP makes a rising transition, the digital control word WSTEER immediately rises to its maximum value. In contrast, when VPOS-VNEG becomes smaller than VOFF and VCOMP makes a falling transition, WSTEER decreases stepwise. This stepwise reduction ensures a predictable and controlled ramp down of IPULSE, allowing the feedback loop to adjust correctly in a way similar to that illustrated in FIG. 7.

FIG. 12 illustrates an alternative implementation of digital steering, where the startup pulse IPULSE is generated as a train of pulses with decreasing magnitudes. This method ensures that if a large pulse brings transient departure from the target operating point, subsequent pulses of lower magnitude allow the feedback loop to adjust progressively.

However, the method proposed in this invention disclosure is also applicable to other configurations where the start circuit has current mode inputs, that is, senses or detects one or more currents in one or more branches in the bandgap core or anywhere in the feedback loop or has a voltage mode output, that is, generates or outputs a voltage quantity at its output terminal that is in turn applied to any net of the bandgap reference circuit.

The invention proposes a method for ensuring reliable startup of a bandgap reference circuit, which comprises a bandgap core with at least two branches, a feedback loop, and a startup circuit. The method includes generating a startup stimulus with an initial magnitude sufficient to transition the circuit from an inactive state to an active state, controlling the progressive reduction of this stimulus over time, and modifying the local time constants of the bandgap reference circuit to prevent a condition where the transient decline of a voltage across one branch is faster than the transient decline of a voltage across another branch. This ensures that the voltages across the branches of the bandgap core converge to a target operating point, resulting in a reliable startup process.

In one embodiment, the progressive reduction of the startup stimulus is controlled by an analog steering mechanism. This mechanism generates a continuous control signal that gradually reduces the magnitude of the startup stimulus over time. This approach provides smooth and precise control of the transient behavior, making it particularly well-suited for applications requiring fast and reliable startup.

Alternatively, the reduction of the startup stimulus can be controlled by a digital steering mechanism, which generates a sequence of pulses with stepwise decreasing magnitudes. Each pulse represents a discrete reduction in the startup stimulus, enabling straightforward implementation with the digital design methodology.

The method can also include modifying the local time constants of the bandgap reference circuit to ensure that the transient decline of the voltages across the bandgap core branches is in accordance with their static characteristics, in particular to ensure that the transient decline does not bring opposite difference of instantaneous values of said voltages, contrast to their static characteristics.

One approach involves modifying the local time constants by attaching a timing capacitor between one branch of the bandgap core and a reference potential. The minimum capacitance of this timing capacitor is determined to ensure that the transient decline of branch voltages is in accordance with their static characteristics.

Another approach involves modifying the local time constants by attaching a capacitor to the output of the operational amplifier in the feedback loop. This capacitor ensures correct transient dynamics by slowing the response of the feedback loop. The minimum capacitance required is determined to ensure that the transient decline of branch voltages is in accordance with their static characteristics.

Adjusting the capacitance of the Miller compensation capacitor is another way to modify the local time constants. Again, the minimum capacitance required is determined to ensure that the transient decline of branch voltages is in accordance with their static characteristics.

The method may also involve optimizing the bandwidth of the feedback loop to prevent the failure mode. This is achieved by determining the maximum allowable bandwidth that ensures that the transient decline of branch voltages is in accordance with their static characteristics.

Another option is to adjust the unity gain frequency of the feedback loop. Again, the maximum unity gain frequency is determined to ensure that the transient decline of branch voltages is in accordance with their static characteristics.

The invention further includes configuring the startup circuit to limit the maximum amplitude of the startup pulse. By capping the peak value of the startup stimulus, this approach minimizes the risk of transient overdrive that is a necessary condition of entering the failure mode.

1. A method for obtaining reliable startup of a bandgap reference circuit, the bandgap reference circuit comprising a bandgap core with at least two branches, a feedback loop, and a startup circuit, the method comprising:
generating a startup stimulus with an initial magnitude sufficient to transition the circuit from an inactive state to an active state;
controlling the decline of the startup stimulus by regulating its reduction progressively over time; and
modifying local time constants of the bandgap reference circuit, to prevent a condition in which the transient decline of a voltage across said first branch is faster than the transient decline of a voltage across said second branch,
whereby the voltages across the branches of the bandgap core converge to a target operating point.

2. The method of claim 1, wherein the decline of the startup stimulus is controlled by an analog steering mechanism configured to generate a continuous, gradual reduction in magnitude.

3. The method of claim 1, wherein the decline of the startup stimulus is controlled by a digital steering mechanism that a produces a sequence of pulses with stepwise decreasing magnitudes.

4. The method of claim 1, wherein modifying local time constants of the bandgap reference circuit includes attaching a timing capacitor between a first branch of the bandgap core and a reference potential and determining the minimum capacitance of said capacitor to prevent the condition.

5. The method of claim 1, wherein modifying local time constants of the bandgap reference circuit includes attaching a capacitor at the output of an operational amplifier in the feedback loop and determining the minimum capacitance of said capacitor to prevent the condition.

6. The method of claim 1, wherein modifying local time constants of the bandgap reference circuit comprises sizing the capacitance of the Miller compensation capacitor, after determining the minimum capacitance of the Miller compensation capacitor to prevent the condition.

7. The method of claim 1, wherein modifying local time constants of the bandgap reference circuit comprises sizing the bandwidth of the feedback loop, after determining the maximum bandwidth to prevent the condition.

8. The method of claim 1, wherein modifying local time constants of the bandgap reference circuit comprises sizing the unity gain frequency of the feedback loop, after determining the maximum unity gain frequency to prevent the condition.

9. The method of claim 1, wherein the startup circuit is configured to limit the maximum amplitude of the startup pulse.

10. A bandgap reference circuit obtained by the method of claim 1.

11. A circuit comprising:
a band-gap reference circuit according to claim 10;
the startup circuit having:
a voltage comparator of two input voltages (VPOS and VNEG);a control block configured to process the output (VCOMP) of the comparator; and a converter configured to generate a startup pulse (IPULSE) based on the output of said control block.

12. The circuit according to claim 11, wherein the voltage comparator comprises a hysteresis mechanism configured to introduce a predefined spacing between a rising input threshold and a falling input threshold.

13. The circuit according to claim 11, comprising an additional offset voltage (VOFF) which is independently applied to one or both inputs of the comparator.
